(19) United States
(12) Patent Application Publication
(10) Pub. No.: US 2026/0190007 A1
(43) Pub. Date: Jul. 2, 2026

(54) METHOD AND DEVICE FOR SIMULTANEOUSLY TRANSMITTING CONFIGURATIONS FOR ADDING AND CHANGING CONDITIONAL PSCELL IN A COMMUNICATION SYSTEM

(71) Applicant: Samsung Electronics Co., Ltd., Suwon-si, Gyeonggi-do (KR)

(72) Inventors: Seungri JIN, Suwon-si (KR); June HWANG, Suwon-si (KR)

(21) Appl. No.: 19/126,514

(22) PCT Filed: Nov. 2, 2023
(86) PCT No.: PCT/KR2023/017403

§ 371 Date: May 1, 2025

(30) Foreign Application Priority Data
Nov. 2, 2022 (KR) 10-2022-0144610

(51) Int. Cl. H04W 36/36; H04W 76/20; H04W 76/30

(52) U.S. Cl. CPC H04W 36/362; H04W 76/20; H04W 76/30

(57) ABSTRACT

The present disclosure relates to a 5G or 6G communication system to support a higher data transmission rate. According to the present disclosure, a method for more efficiently adding and changing a conditional PSCell is provided.

### TECHNICAL FIELD

The present disclosure relates to operations of a terminal and a base stations in a mobile communication system. More specifically, the present disclosure relates to a method and a device for simultaneously transmitting configurations for adding and changing conditional PSCell (primary SCG (secondary cell group) cell).

### BACKGROUND ART

5G mobile communication technologies define broad frequency bands such that high transmission rates and new services are possible, and may be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles on the basis of information regarding positions and states of vehicles transmitted by the vehicles and for enhancing user convenience, NR-U (New Radio Unlicensed) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services on the basis of UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next generation distributed computing technology for implementing services at levels of complexity exceeding the limit of UE operation capability by utilizing ultra-high-performance communication and computing resources.

As described above and with the development of wireless communication systems, various services have become available, and methods for providing these services smoothly are required.

### DISCLOSURE

### Technical Problem

After the SCG (secondary cell group) change is performed, all candidate SCG configurations stored in the terminal are released. Accordingly, continuous CPAC (CPA (conditional PSCell addition) and CPC (conditional PSCell change)) operations are impossible. In other words, once CPAC is applied and performed, the base station must reconfigure the CPAC configurations in the terminal through RRC configurations in order to perform CPAC operation again. In addition, since CPA and CPC have different configuration scenarios, previously they were not configured simultaneously. Accordingly, CPA and CPC configurations were configured separately depending on whether the terminal applies dual connectivity (hereinafter, DC). In order to solve this problem, a more efficient conditional PSCell addition and change method needs to be designed.

The technical problems to be achieved in the present invention are not limited to the technical problems mentioned above, and other technical problems not mentioned will be clearly understood by a person having ordinary skill in the technical field to which the present invention belongs from the description below.

### Technical Solution

In order to solve the above problems, the present disclosure provides a method performed by a terminal of a wireless communication system, comprising:
receiving, from a base station, a radio resource control (RRC) reconfiguration message comprising condition information for a conditional primary secondary cell group (SCG) cell (PSCell) addition, configuration information for the conditional PSCell addition, condition information for a conditional PSCell change, and configuration information for the conditional PSCell change; as a response to the RRC reconfiguration message, transmitting, to the base station, an RRC reconfiguration complete message; identifying whether a condition for the conditional PSCell addition or the conditional PSCell change is satisfied; and in case that the condition is satisfied, performing the conditional PSCell addition or the conditional PSCell change, wherein the condition information for the conditional PSCell addition, the configuration information for the conditional PSCell addition, the condition information for the conditional PSCell change, and the configuration information for the conditional PSCell change are retained for a subsequent addition or change of a PSCell.

In addition, the condition information for the conditional PSCell addition, the configuration information for the conditional PSCell addition, the condition information for the conditional PSCell change, and the configuration information for the conditional PSCell change are retained until information for new conditional PSCell addition or conditional PSCell change, or a message associated with a release of configuration information is received from the base station after the conditional PSCell addition or the conditional PSCell change.

In addition, a subsequent conditional PSCell addition or a subsequent conditional PSCell change is supported based on the condition information for the conditional PSCell addition, the configuration information for the conditional PSCell addition, the condition information for the conditional PSCell change, and the configuration information for the conditional PSCell change.

In addition, the RRC reconfiguration message comprises information on a cell that serves as a reference, and only condition or configuration information differing from the information on the cell is configured based on the information on the cell.

In order to solve the above problems, the present disclosure provides a method performed by a base station of a wireless communication system, comprising:
transmitting, to a terminal, a radio resource control (RRC) reconfiguration message comprising condition information for a conditional primary secondary cell group (SCG) cell (PSCell) addition, configuration information for the conditional PSCell addition, condition information for a conditional PSCell change, and configuration information for the conditional PSCell change; and as a response to the RRC reconfiguration message, receiving, from the terminal, an RRC reconfiguration complete message, wherein the condition information for the conditional PSCell addition, the configuration information for the conditional PSCell addition, the condition information for the conditional PSCell change, and the configuration information for the conditional PSCell change are retained for a subsequent addition or change of a PSCell.

In addition, transmitting, to the terminal, information for new conditional PSCell addition or conditional PSCell change, or a message associated with a release of configuration information after the conditional PSCell addition or the conditional PSCell change.

In addition, a subsequent conditional PSCell addition or a subsequent conditional PSCell change is supported based on the condition information for the conditional PSCell addition, the configuration information for the conditional PSCell addition, the condition information for the conditional PSCell change, and the configuration information for the conditional PSCell change.

In addition, the RRC reconfiguration message comprises information on a cell that serves as a reference, and only condition or configuration information differing from the information on the cell is configured to the terminal based on the information on the cell.

In order to solve the above problems, the present disclosure provides a terminal of a wireless communication system, comprising: a transceiver; and at least one processor coupled with the transceiver and configured to: receive, from a base station, a radio resource control (RRC) reconfiguration message comprising condition information for a conditional primary secondary cell group (SCG) cell (PSCell) addition, configuration information for the conditional PSCell addition, condition information for a conditional PSCell change, and configuration information for the conditional PSCell change, as a response to the RRC reconfiguration message, transmit, to the base station, an RRC reconfiguration complete message, identify whether a condition for the conditional PSCell addition or the conditional PSCell change is satisfied, and in case that the condition is satisfied, perform the conditional PSCell addition or the conditional PSCell change, wherein the condition information for the conditional PSCell addition, the configuration information for the conditional PSCell addition, the condition information for the conditional PSCell change, and the configuration information for the conditional PSCell change are retained for a subsequent addition or change of a PSCell.

In order to solve the above problems, the present disclosure includes a base station of a wireless communication system, comprising: a transceiver; and at least one processor coupled with the transceiver and configured to: transmit, to a terminal, a radio resource control (RRC) reconfiguration message comprising condition information for a conditional primary secondary cell group (SCG) cell (PSCell) addition, configuration information for the conditional PSCell addition, condition information for a conditional PSCell change, and configuration information for the conditional PSCell change, and as a response to the RRC reconfiguration message, receive, from the terminal, an RRC reconfiguration complete message, wherein the condition information for the conditional PSCell addition, the configuration information for the conditional PSCell addition, the condition information for the conditional PSCell change, and the configuration information for the conditional PSCell change are retained for a subsequent addition or change of a PSCell.

### Advantageous Effects

According to the continuous CPAC support method proposed in the present disclosure, the base station may configure and instruct the terminal for the candidate SCG for continuous CPAC. Accordingly, the terminal may maintain the configuration even after the SCG configuration is changed, and the base station may support the continuous CPAC operation according to the channel status, etc. without additional RRC configuration, thereby reducing unnecessary RRC signaling and enabling dynamic CPAC operation according to the channel status. In particular, since the configurations related to CPC and CPA (conditions for CPA and CPC, and configurations applied after handover) may be transmitted to the terminal at once and managed, additional RRC configurations may be reduced.

The effects obtainable from the present disclosure are not limited to the effects mentioned above, and other effects not mentioned will be clearly understood by a person skilled in the art to which the present disclosure belongs from the description below.

### DESCRIPTION OF DRAWINGS

FIG. 1 is a diagram illustrating the structure of a long term evolution (LTE) system according to one embodiment of the present disclosure.

FIG. 2 is a diagram illustrating a wireless protocol structure in an LTE system according to one embodiment of the present disclosure.

FIG. 3 is a diagram illustrating the structure of a next-generation mobile communication system according to one embodiment of the present disclosure.

FIG. 4 is a diagram illustrating a wireless protocol structure of a next-generation mobile communication system according to one embodiment of the present disclosure.

FIG. 5 is a diagram illustrating the overall operation of performing a conditional PSCell addition procedure in an LTE system or a new radio (NR) system according to one embodiment of the present disclosure.

FIGS. 6A and 6B are diagrams illustrating the overall operation of performing a conditional PSCell change procedure in an LTE system or NR system according to one embodiment of the present disclosure.

FIG. 7 is a diagram illustrating a method of performing CPAC configurations simultaneously as proposed in the present disclosure to continuously perform conditional PSCell addition and change procedures.

FIGS. 8A, 8B, and 8C are diagrams illustrating the overall operation of performing continuous conditional PSCell addition and change procedures according to one embodiment of the present disclosure.

FIG. 9 is a diagram illustrating a terminal operation according to one embodiment of the present disclosure, specifically the terminal operation when conditional PSCell addition and change are applied continuously.

FIG. 10 is a diagram illustrating a base station operation according to one embodiment of the present disclosure, specifically the base station operation when conditional PSCell addition and change are applied continuously.

FIG. 11 is a block diagram illustrating a configuration of a terminal according to one embodiment of the present disclosure.

FIG. 12 is a block diagram illustrating a configuration of a base station according to one embodiment of the present disclosure

### MODE FOR DISCLOSURE

Hereinafter, the operating principle of the present invention will be described in detail with reference to the attached drawings. In the following description of the present invention, in the case that it is determined that a specific description of a related known function or configuration may unnecessarily obscure the gist of the present invention, the detailed description thereof will be omitted. In addition, the terms described below are terms defined in consideration of the functions in the present invention, and these may vary depending on the intention or custom of the user or operator. Therefore, the definitions should be made on the basis of the contents throughout this specification. In the following description, terms for identifying a connection node, terms with reference to network entities, terms with reference to messages, terms with reference to interfaces between network objects, terms with reference to various identification information, etc. are examples for the convenience of explanation. Therefore, the present invention is not limited to the terms described below, and other terms with reference to objects having equivalent technical meanings may be used.

For convenience of explanation below, the present invention uses terms and names defined in the 3GPP LTE (3rd Generation Partnership Project Long Term Evolution) standard. However, the present invention is not limited by the above terms and names, and may be equally applied to systems that comply with other standards.

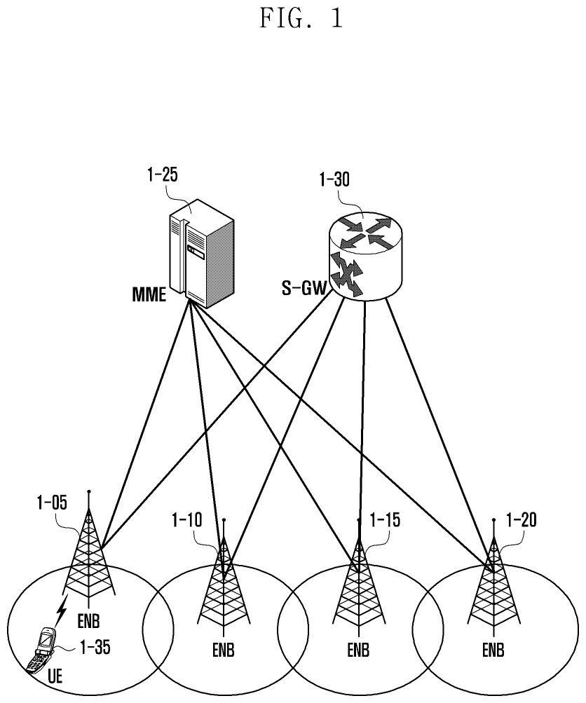

FIG. 1 is a diagram illustrating the structure of an LTE system according to one embodiment of the present disclosure.

With reference to FIG. 1, as illustrated, a wireless access network of an LTE system is composed of next-generation base stations (Evolved Node Bs, hereinafter referred to as eNBs, Node Bs or base stations) 1-05, 1-10, 1-15, and 1-20, a Mobility Management Entity (MME) 1-25 and a Serving-Gateway (S-GW) 1-30. A user equipment (hereinafter referred to as UE or terminal) 1-35 accesses an external network through the eNBs 1-05 to 1-20 and the S-GW 1-30.

In FIG. 1, eNBs 1-05 to 1-20 correspond to existing Node Bs of the UMTS system. The eNBs are connected to UEs 1-35 through a wireless channel and perform a more complex role than existing Node Bs. In the LTE system, all user traffic, including real-time services such as VoIP (Voice over IP) through the Internet Protocol, are serviced through a shared channel. Therefore, a device that collects status information such as buffer status, available transmission power status, and channel status of UEs and performs scheduling is required, and the eNBs 1-05 to 1-20 are in charge of this. One eNB typically controls multiple cells. For example, in order to implement a transmission rate of 100 Mbps, the LTE system uses, for example, orthogonal frequency division multiplexing (OFDM) as a wireless access technology in a 20 MHz bandwidth. In addition, an adaptive modulation and coding (AMC) method is applied to determine a modulation scheme and a channel coding rate according to the channel status of the terminal. The S-GW 1-30 is a device that provides a data bearer and creates or removes a data bearer according to the control of the MME 1-25. The MME is a device that is responsible for various control functions as well as mobility management functions for the terminal and is connected to multiple base stations.

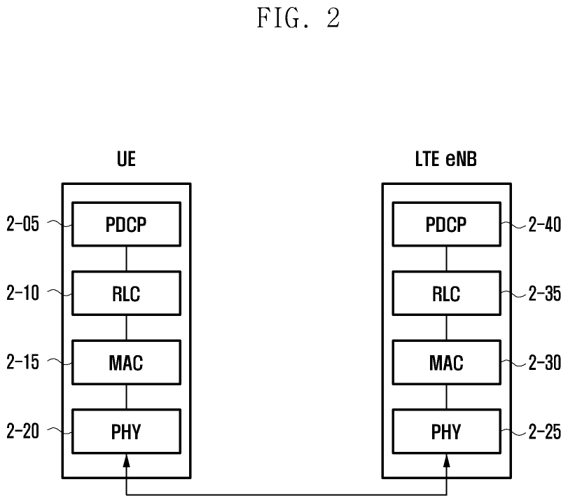

FIG. 2 is a diagram illustrating a wireless protocol structure in an LTE system according to one embodiment of the present disclosure.

With reference to FIG. 2, the wireless protocol of the LTE system consists of PDCP (Packet Data Convergence Protocol) 2-05 and 2-40, RLC (Radio Link Control) 2-10 and 2-35, and MAC (Medium Access Control) 2-15 and 2-30 in the terminal and eNB, respectively. PDCP 2-05 and 2-40 is responsible for operations such as IP header compression/reconstruction. The main functions of PDCP are summarized as follows.
Header compression and decompression (ROHC only)
Transfer of user data
In-sequence delivery of upper layer PDUs at PDCP re-establishment procedure for RLC AM
For split bearers in DC (only support for RLC AM): PDCP PDU routing for transmission and PDCP PDU reordering for reception
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink.
Radio Link Control (hereinafter, RLC) 2-10 and 2-35 reconfigures PDCP PDU (Packet Data Unit) to an appropriate size and performs ARQ operations, etc. The main functions of RLC are summarized as follows.
Transfer of upper layer PDUs
Error Correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

MAC 2-15 and 2-30 is connected to multiple RLC layer devices configured in one terminal, and performs the operation of multiplexing RLC PDUs into MAC PDUs and demultiplexing RLC PDUs from MAC PDUs. The main functions of MAC are summarized as follows.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through HARQ
Priority handling between logical channels of one UE
Priority handling between UEs by means of dynamic scheduling
MBMS service identification
Transport format selection
Padding

The physical layer 2-20 and 2-25 performs an operation of channel-coding and modulating upper layer data, converting them into OFDM symbols and transmitting them through a wireless channel, or demodulating and channel-decoding OFDM symbols received through a wireless channel and transmitting them to the upper layer. In addition, the physical layer also uses HARQ (Hybrid ARQ) for additional error correction, and the receiver transmits whether or not the packet transmitted by the transmitter was received as 1 bit. This is called HARQ ACK/NACK information. Downlink HARQ ACK/NACK information for uplink transmission may be transmitted through a PHICH (Physical Hybrid-ARQ Indicator Channel) physical channel, and uplink HARQ ACK/NACK information for downlink transmission may be transmitted through a PUCCH (Physical Uplink Control Channel) or PUSCH (Physical Uplink Shared Channel) physical channel.

Meanwhile, the PHY layer may be composed of one or more frequencies/carriers, and the technology of configuring and using multiple frequencies simultaneously is called carrier aggregation (CA). CA technology is the use of a single carrier for communication between a terminal (or User Equipment (UE)) and a base station (E-UTRAN NodeB, eNB), with the primary carrier and one or more additional secondary carriers, which can dramatically increase the transmission capacity by the number of secondary carriers. Meanwhile, in LTE, the cell within the base station that uses the primary carrier is called PCell (Primary Cell), and the cell that uses the secondary carrier is called SCell (Secondary Cell).

Although not shown in this drawing, an RRC (Radio Resource Control, hereinafter referred to as RRC) layer exists above the PDCP layer of each terminal and base station, and the RRC layer may exchange connection and measurement-related configuration control messages for radio resource control.

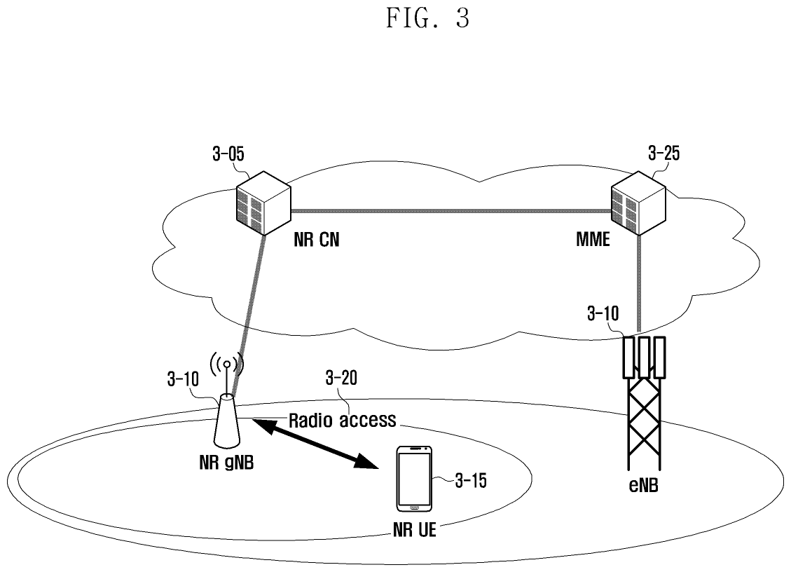

FIG. 3 is a diagram illustrating the structure of a next-generation mobile communication system according to one embodiment of the present disclosure.

With reference to FIG. 3, as illustrated, a wireless access network of a next-generation mobile communication system is composed of a next-generation base station (New Radio Node B, hereinafter referred to as NR NB) 3-10 and an NR CN (New Radio Core Network, or NG CN: Next Generation Core Network) 3-05. A user terminal (New Radio User Equipment, hereinafter referred to as NR UE or terminal) 3-15 accesses an external network through an NR NB 3-10 and an NR CN 3-05.

In FIG. 3, NR NB 3-10 corresponds to an eNB (Evolved Node B) of an existing LTE system. The NR NB may be connected to NR UE 3-15 through a wireless channel and may provide a service that is superior to that of an existing Node B. In the next-generation mobile communication system, since all user traffic is serviced through a shared channel, a device that collects status information such as buffer status, available transmission power status, and channel status of UEs and performs scheduling is required, and the NR NB 3-10 is in charge of this. One NR NB typically controls multiple cells. In order to implement ultra-high-speed data transmission compared to the existing LTE, it may have a bandwidth greater than the existing maximum bandwidth, and an orthogonal frequency division multiplexing (OFDM) scheme may be used as a wireless access technology and additionally beamforming technology may be grafted. In addition, it applies the Adaptive Modulation & Coding (AMC) method that determines the modulation scheme and channel coding rate according to the channel status of the terminal. NR CN 3-05 performs functions such as mobility support, bearer configuration, and QoS configuration. NR CN is a device that is responsible for various control functions as well as mobility management functions for the terminal and is connected to multiple base stations. In addition, the next-generation mobile communication system may be linked with the existing LTE system, and NR CN is connected to MME 3-25 through a network interface. MME is connected to the existing base station, eNB 3-30.

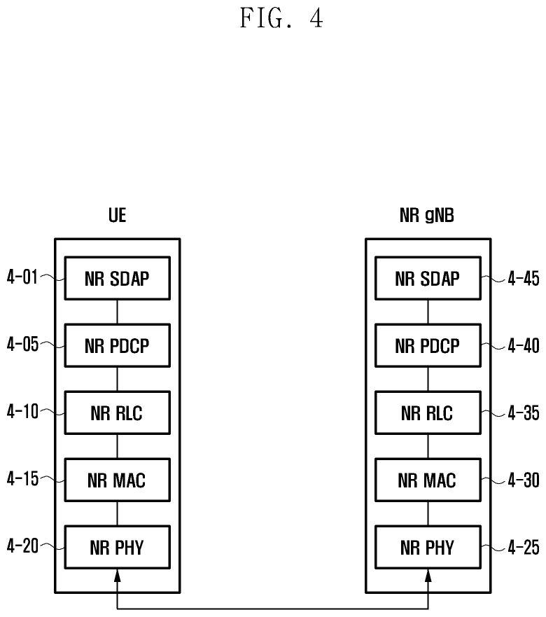

FIG. 4 is a diagram illustrating a wireless protocol structure of a next-generation mobile communication system according to one embodiment of the present disclosure.

With reference to FIG. 4, the wireless protocol of the next-generation mobile communication system consists of NR SDAP 4-01 and 4-45, NR PDCP 4-05 and 4-40, NR RLC 4-10 and 4-35, and NR MAC 4-15 and 4-30 in the terminal and the NR base station, respectively.

Key features of NR SDAP 4-01 and 4-45 may include some of the following.
Transfer of user plane data
Mapping between a QoS flow and a DRB for both DL and UL
Marking QoS flow ID in both DL and UL packets
Reflective QoS flow to DRB mapping for the UL SDAP PDUs

For the SDAP layer device, the terminal may be configured by an RRC message for each PDCP layer device, by bearer, or by logical channel, whether to use the header of the SDAP layer device or whether to use the function of the SDAP layer device, and, in the case that the SDAP header is configured, the terminal may be instructed to update or reconfigure QoS flow of the uplink and downlink and the mapping information for the data bearer with a 1-bit indicator for reflecting NAS QoS (NAS reflective QoS) and a 1-bit indicator for reflecting AS QoS (AS reflective QoS) of the SDAP header. The SDAP header may include QoS flow ID information indicating QoS. The QoS information may be used as data processing priority, scheduling information, etc. to support a desired service.

The main functions of NR PDCP 4-05 and 4-40 may include some of the following functions:
Header compression and decompression (ROHC only)
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The reordering function of the NR PDCP device described above may refer to a function of sequentially reordering PDCP PDUs received from a lower layer on the basis of a PDCP SN (sequence number), may include a function of transmitting data to an upper layer in the reordered order, may include a function of directly transmitting data without considering the order, may include a function of recording lost PDCP PDUs by reordering the order, may include a function of reporting a status of lost PDCP PDUs to the transmitting side, and may include a function of requesting retransmission of lost PDCP PDUs.

Key features of NR RLC 4-10 and 4-35 may include some of the following:
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery of an NR RLC device refers to a function of sequentially delivering RLC SDUs received from a lower layer to a higher layer, and may include a function of reassembling and delivering a single RLC SDU if it was originally received split into multiple RLC SDUs, may include a function of reordering received RLC PDUs on the basis of RLC SN (sequence number) or PDCP SN (sequence number), and may include a function of recording lost RLC PDUs in the reordered sequence, and may include a function of reporting the status of lost RLC PDUs to the transmitting side, may include a function of requesting retransmission of the lost RLC PDUs, and may include a function of sequentially delivering only the RLC SDUs prior to the lost RLC SDU, if there is a lost RCL SDU, to the higher layer, or, if a predetermined timer has expired even though there is a lost RLC SDU, it may include a function of sequentially delivering all RLC SDUs received before the timer started to the higher layer, or if a predetermined timer has expired even though there is a lost RLC SDU, it may include a function of sequentially delivering all RLC SDUs received to date to the higher layer. The NR RLC layer may also sequentially process the RLC PDUs in the order that they are received (in order of arrival, regardless of sequence number) and deliver them to the PDCP device in an out-of-sequence delivery, or, in the case of segments, may receive segments stored in a buffer or to be received at a later time, reconstruct them into a single and complete RLC PDU, and process and deliver them to the PDCP device. The NR RLC layer may not include a concatenation function and this function may be performed by the NR MAC layer or replaced by the multiplexing function of the NR MAC layer.

The out-of-sequence delivery function of the NR RLC device mentioned above refers to the function of directly delivering RLC SDUs received from a lower layer to an upper layer regardless of the order, and may include a function of reassembling and delivering multiple RLC SDUs when an original RLC SDU is received as divided into multiple RLC SDUs, and may include a function of storing and arranging the RLC SN or PDCP SN of received RLC PDUs to record any lost RLC PDUs.

The NR MAC 4-15 and 4-30 may be connected to multiple NR RLC layer devices configured in one terminal, and the main functions of NR MAC may include some of the following functions.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

The NR PHY layer 4-20 and 4-25 may perform operations of channel-coding and modulating upper layer data, converting them into OFDM symbols and transmitting them through a wireless channel, or demodulating and channel-decoding OFDM symbols received through a wireless channel and transmitting them to a higher layer.

In the embodiments of the present disclosure below, an improved technique for a PSCell addition and change, particularly a conditional PSCell addition and change (CPC and CPA, CPAC) procedure will be described. Methods are proposed for enabling CPAC to be triggered continuously by maintaining the corresponding configuration and conditions without performing a configuration release for a candidate SN (Secondary Node) configured from a base station even after an SCG change is performed for an existing CPAC operation. In particular, an operation is proposed for receiving both configurations for CPA and CPC at once when DC (dual connectivity) is not configured in a terminal, and allowing the terminal to maintain the received configurations for CPA and CPC even after performing an SCG addition and change.

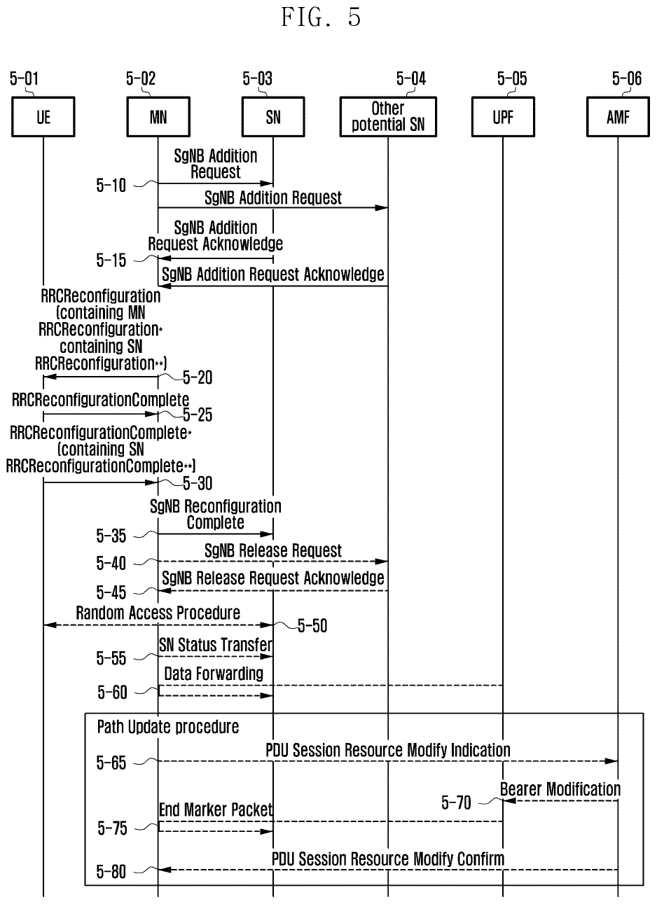

FIG. 5 is a diagram illustrating the overall operation of performing a conditional PSCell addition procedure in an LTE system or an NR system according to one embodiment of the present disclosure.

The terminal 5-01 in the RRC connection state performs data transmission/reception and channel measurement/reporting operations according to the configurations of the connected Master Node (MN) 5-02/base station, and the MN base station 5-02 identifies the need to add an SN to the terminal and identifies whether the SN addition for the terminal is possible for candidate SN nodes. The procedure is performed through the sgNB Addition Request procedure in step 5-10 and the sgNB Addition Request Acknowledge procedure in step 5-15 with each SN node. In step 5-20, the MN base station 5-02 includes CPA-related configurations (e.g., conditions for CPA and RRC configurations related to SCG) received from candidate SNs that allowed SN addition in steps 5-10/5-15 in the RRC configuration message of the MN and transmits the same to the terminal. Meanwhile, in the EN-DC (E-UTRA/NR-DC) situation, the CPA related configurations for the SN are encapsulated in the RRCConnectionReconfiguration message, and in the NE-DC (NR/E-UTRA-DC) and NR-DC (NR/NR-DC) situations, the CPA related configurations for the SN are encapsulated and transmitted in the RRCReconfiguration message. For the convenience of explanation, the case of NR-DC is assumed in this drawing, but the present disclosure is not limited thereto. The SN CPA related configurations included in the RRC configurations may be provided with up to 8 SN CPA configurations through ConditionalReconfiguration as follows. For reference, the corresponding configurations may be equal to the maximum number of MN CHO and SN CPAC related configurations, and the base station may configure up to 8 by considering both MN CHO and SN CPAC. Among the SN CPAC related configurations, condReconfigId indicates the index of the corresponding SN CPAC configuration, and may include a condition (condExecutionCond) for SN CPA indicated by measId and condRRCReconfig which includes SCG configurations applied after the terminal performs SN CPA. The condition (condExecutionCond) for SN CPA may include up to two trigger conditions, and one RS type and up to two different trigger quantities (e.g. RSRP (reference signal received power) and RSRQ (reference signal received quality), RSRP and SINR (signal-to-interference-plus-noise ratio), etc.) may be provided as conditions.

```
TABLE 1
  ConditionalReconfiguration-r16 ::= SEQUENCE {
  attemptCondReconfig-r16 ENUMERATED {true} OPTIONAL, -- Cond
CHO
```

| | |
|---|---|
| condReconfigToRemoveList-r16 | CondReconfigToRemoveList-r16 |

OPTIONAL, -- Need N

| | |
|---|---|
| condReconfigToAddModList-r16 | CondReconfigToAddModList-r16 |

```
OPTIONAL, -- Need N
  ...
  CondReconfigToAddModList-r16 ::= SEQUENCE (SIZE (1..
maxNrofCondCells-r16)) OF CondReconfigToAddMod-r16
  CondReconfigToAddMod-r16 ::= SEQUENCE {
  condReconfigId-r16 CondReconfigId-r16 ,
  condExecutionCond-r16 SEQUENCE (SIZE (1..2)) OF MeasId
OPTIONAL, -- Need M
  condRRCReconfig-r16 OCTET STRING (CONTAINING
RRCReconfiguration ) OPTIONAL, -- Cond condReconfigAdd
  ...,
  [[
  condExecutionCondSCG-r17 OCTET STRING (CONTAINING
CondReconfigExecCondSCG-r17) OPTIONAL -- Need M
  ]]
  }
  CondReconfigExecCondSCG-r17 ::= SEQUENCE (SIZE (1..2)) OF
MeasId
```

In step 5-25, the terminal may transmit an RRCReconfigurationComplete message to the MN base station 5-02 in response to the received RRC configuration (including the configuration for MN and SN, especially including the CPA related configuration). Thereafter, in the case that a CPA related condition received from a specific SN is satisfied, the terminal may trigger an SN addition procedure for the corresponding SN. That is, in step 5-30, the terminal generates an MN RRCReconfigurationComplete message including an SN RRCReconfigurationComplete message for the SN for which the SN addition procedure is triggered (the SN for which the CPA condition is satisfied) and transmits it to the MN base station 5-02. In step 5-35, the MN base station 5-02 transmits an sgNB Reconfiguration Complete message to the SN base station 5-03 for which the CPA condition is satisfied, that is, where the terminal performs SN addition, to notify the SN addition operation of the terminal. In addition, in step 5-40, an SgNB Release Request message is transmitted to the candidate SN base stations to instruct the release of the SCG configurations transmitted to the terminal to which SN addition has not been performed, and in step 5-45, each candidate SN transmits an SgNB Release Request Acknowledge in response to the message. Meanwhile, the procedures 5-40 and 5-45 may be omitted depending on the implementation. In step 5-50, the terminal may perform a random access procedure for SN addition for the SN where CPA is triggered. Meanwhile, the operation is performed only when a security key update is required, and may be omitted in other cases. In step 5-55, the MN base station 5-02 may transmit SN (sequence number) Status to the SN base station 5-03, and, in step 5-60, it may perform a procedure for transmitting data from UPF 5-05 to the SN base station 5-03. In addition, as an action for path update in step 5-65, the MN base station 5-02 may transmit a PDU session resource change indicator to the AMF 5-06, in step 5-70, the AMF 5-06 and the UPF 5-05 may perform a bearer modification procedure, and in step 5-75, the UPF 5-05 may transmit a PDU packet including an End marker to the MN base station 5-02 to instruct a change of the previous bearer. In step 5-80, the AMF 5-06 may transmit a PDU session resource change acknowledge message to the MN base station 5-02 to instruct that the PDU session resource change is completed.

Meanwhile, although steps 5-10 to 5-80 are illustrated as being performed sequentially in FIG. 5, the present disclosure is not limited thereto. For example, some of steps 5-10 to 5-80 may be performed in different orders or may be performed simultaneously. In addition, some of steps 5-10 to 5-80 may be omitted.

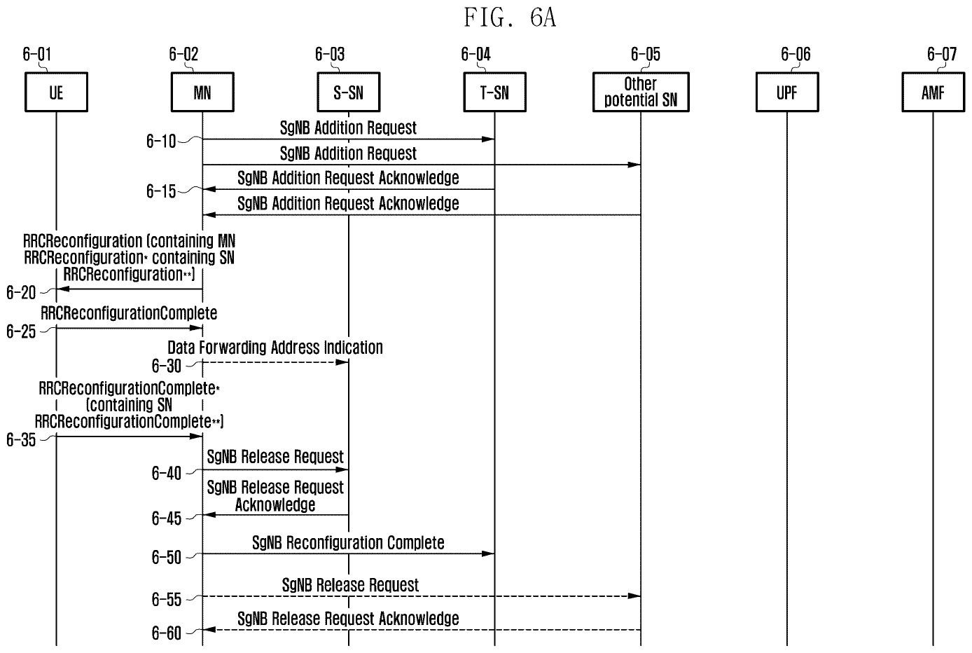

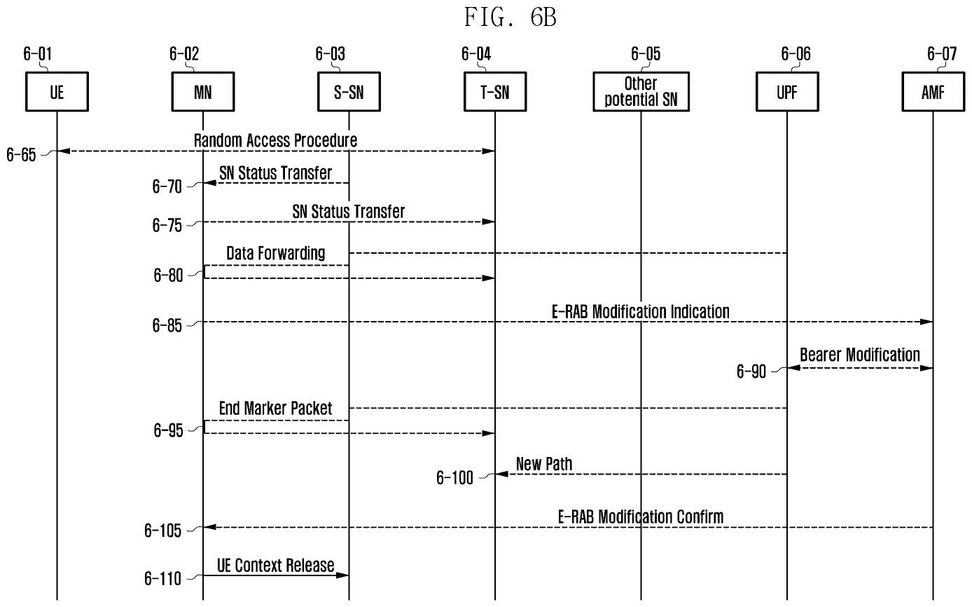

FIGS. 6A and 6B are diagrams illustrating the overall operation of performing a conditional PSCell change procedure in an LTE system or NR system according to one embodiment of the present disclosure.

With reference to FIGS. 6A and 6B, a terminal 6-01 in an RRC connection state may perform data transmission/reception and channel measurement/reporting operations according to the configurations of a connected master node (MN) 6-02/base station. The MN base station 6-02 may identify whether the terminal needs to change from the current source SN base station 6-03 to another SN 6-04 and 6-05 and may identify whether SN change for the terminal is possible for the SN nodes 6-04 and 6-05 that can be candidates. The procedure may be performed through the sgNB Addition Request procedure in step 6-10 and the sgNB Addition Request Acknowledge procedure in step 6-15 with each SN node 6-04 and 6-05. In step 6-20, the MN base station 6-02 may transmit to the terminal the CPC related configurations (e.g., conditions for CPC and RRC configurations related to SCG) received from the candidate SNs 6-04 and 6-05 that allowed SN addition and change in steps 6-10/6-15, by including them in the RRC configuration message of the MN. In the EN-DC situation, the CPC related configurations for the SN are encapsulated in the RRCConnectionReconfiguration message and in the NE-DC and NR-DC situations, the CPC related configurations for the SN are encapsulated and transmitted in the RRCReconfiguration message. For the convenience of explanation, the case of NR-DC is assumed in this drawing, but the present disclosure is not limited thereto. The SN CPC related configurations included in the RRC configuration may be provided with up to 8 SN CPC configurations through ConditionalReconfiguration as follows. For reference, the corresponding configuration may be equal to the maximum number of MN CHO and SN CPCC related configurations, and the base station may configure up to 8 considering both MN CHO and SN CPCC. Among the SN CPCC related configurations, condReconfigId means the index of the corresponding SN CPCC configuration, and may include a condition (condExecutionCond) for SN CPC indicated by measId and condRRCReconfig which includes SCG configurations applied after the terminal performs SN CPC. The condition (condExecutionCond) for SN CPC may include up to two trigger conditions, and one RS type and up to two different trigger quantities (e.g. RSRP and RSRQ, RSRP and SINR, etc.) may be provided as conditions.

TABLE 2

| ConditionalReconfiguration-r16 ::= SEQUENCE { | |
|---|---|
| attemptCondReconfig-r16 ENUMERATED {true} OPTIONAL, -- Cond | |
| CHO | |
| condReconfigToRemoveList-r16 | CondReconfigToRemoveList-r16 |
| OPTIONAL, -- Need N | |
| condReconfigToAddModList-r16 | CondReconfigToAddModList-r16 |

```
OPTIONAL, -- Need N
  ...
  CondReconfigToAddModList-r16 ::= SEQUENCE (SIZE (1..
maxNrofCondCells-r16)) OF CondReconfigToAddMod-r16
  CondReconfigToAddMod-r16 ::= SEQUENCE {
  condReconfigId-r16 CondReconfigId-r16,
  condExecutionCond-r16 SEQUENCE (SIZE (1..2)) OF MeasId
OPTIONAL, -- Need M
  condRRCReconfig-r16 OCTET STRING (CONTAINING
RRCReconfiguration ) OPTIONAL, -- Cond condReconfigAdd
  ...,
  [[
  condExecutionCondSCG-r17 OCTET STRING (CONTAINING
CondReconfigExecCondSCG-r17) OPTIONAL -- Need M
  ]]
  }
  CondReconfigExecCondSCG-r17 ::= SEQUENCE (SIZE (1..2)) OF
MeasId
```

In step 6-25, the terminal may transmit an RRCReconfigurationComplete message to the MN base station 6-02 in response to the received RRC configuration (including the configuration for MN and SN, especially including the CPC related configuration). In step 6-30, the terminal may indicate a data forwarding address to the source SN base station 6-03. Meanwhile, the step may be omitted. Thereafter, in the case that a CPC related condition received from a specific SN is satisfied, the terminal may trigger an SN change procedure for the SN. That is, in step 6-30, the terminal generates the MN RRCReconfigurationComplete message including an SN RRCReconfigurationComplete message for the SN for which the SN change procedure is triggered (the SN for which the CPC condition is satisfied) and transmits it to the MN base station 6-02. The MN base station 6-02 transmits an SgNB Release Request message requesting SCG configuration release to the source SN base station 6-03 in step 6-40, and the source SN base station 6-03 responds by transmitting an SgNB Release Request Acknowledge message in step 6-45. In step 6-50, the MN base station 6-02 transmits an sgNB Reconfiguration Complete message to the target SN base station 6-04 for which the CPC condition is satisfied, that is, where the terminal performs SN change, to notify the terminal of the SN change operation. In addition, in step 6-55, an SgNB Release Request message is transmitted to the candidate SN base stations 6-05 whose SN has not been changed, instructing the release of the SCG configurations transmitted to the terminal, and in step 6-60, an SgNB Release Request Acknowledge is transmitted to each of the candidate SN base stations 6-05 in response to the above message. Meanwhile, the 6-55 and 6-60 procedures may be omitted depending on the implementation.

In step 6-65, the terminal may perform a random access procedure for SN change for the target SN for which CPC is triggered. This operation is performed only when a security key update is required, and may be omitted in other cases. In step 6-70, the MN base station 6-02 receives SN (sequence number) Status from the source SN base station 6-03, and transfers the SN (sequence number) Status received in step 6-75 to the target SN base station 6-04. In step 6-80, a procedure for transferring data from the UPF 6-06 to the target SN base station 6-04 may be performed. In addition, as an action for path update in step 6-85, the MN base station 6-02 may transmit a PDU session resource change indicator to the AMF 6-07, in step 6-90, the AMF 6-07 and the UPF 6-06 may perform a bearer modification procedure, and in step 6-95, the UPF 6-06 may instruct the MN base station 6-02 to change the previous bearer by transmitting a PDU packet including an End marker. In step 6-100, the UPF 6-06 may instruct the target SN base station 6-04 to a new path. In step 6-105, the AMF 6-07 may transmit a PDU session resource change confirmation message to the MN base station 6-02 indicating that the PDU session resource change has been completed, and in step 6-110, the MN base station 6-02 may instruct the source SN base station 6-03 to release the terminal context.

Meanwhile, although steps 6-10 to 6-110 are illustrated as being performed sequentially in FIGS. 6A and 6B, the present disclosure is not limited thereto. For example, some of steps 6-10 to 6-110 may be performed in different orders or may be performed simultaneously. In addition, some of steps 6-10 to 6-110 may be omitted.

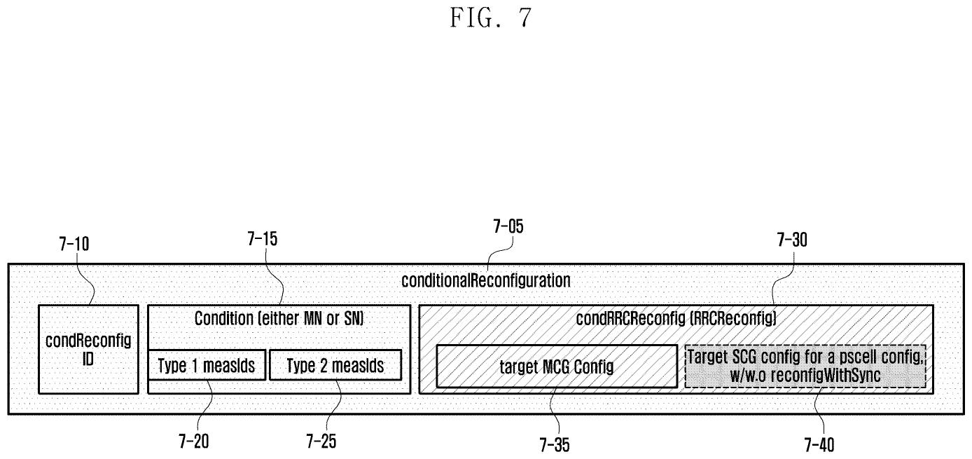

FIG. 7 is a diagram illustrating a method of performing CPAC configurations simultaneously as proposed in the present disclosure to continuously perform conditional PSCell addition and change procedures.

First, an example scenario is described in relation to a method for simultaneously configuring CPA and CPC configurations for continuous conditional PSCell addition and modification procedures, which is featured in embodiments of the present disclosure below.
Step 1: The terminal is in a single RRC connection state to the serving cell (PCell, cell A) (single connectivity state without DC configuration).
Step 2: The terminal simultaneously receives CPA and CPC configuration for conditional PSCell addition and change procedures from the serving cell (PCell, cell A).
Step 3: The terminal adds cell B present in SN1 as PSCell according to the CPA procedure configured by the terminal.
Step 4: The terminal changes PSCell to cell C present in SN2 according to the CPC procedure configured by the terminal.
Step 5: The terminal changes PSCell back to cell B present in SN1 according to the CPC procedure configured by the terminal.

That is, the scenario is a scenario in which the terminal is in an RRC connection state for the PCell, DC is configured through CPA, and then PSCell changes are continuously performed through CPC. This is different from a scenario in which only the CPA configuration is transmitted to the terminal in a single connectivity state, and then the previous CPA configuration is deleted, and the CPC configuration is added after the DC is configured. The biggest feature of the scenario covered in this embodiment is that the CPA configuration and the CPC configuration are simultaneously transmitted to the terminal in a single connectivity state in step 2, and the terminal performs the CPAC procedure while storing and maintaining the corresponding configurations.

For convenience of explanation, this drawing assumes the case of NR-DC, but the present disclosure is not limited thereto. SN CPA related configurations included in the RRC configurations may provide up to 8 SN CPA configurations through ConditionalReconfiguration 7-05 as follows. For reference, the corresponding configurations may be equal to the maximum number of MN CHO and SN CPAC related configurations, and the base station may configure up to 8 considering both MN CHO and SN CPAC. Among the SN CPAC related configurations, condReconfigId 7-10 indicates the index of the corresponding SN CPAC configuration, and may include a condition (condExecutionCond) 7-15 for SN CPA indicated by measId 7-20 and 7-25, and condRRCReconfig 7-30 including SCG configurations applied after the terminal performs SN CPA. The target MCG configurations 7-35 and the SCG configurations 7-35 for the target PSCell may also be simultaneously transmitted to condRRCReconfig 7-30 including the SCG configurations.

Previously, a condition (condExecutionCond) for SN CPA may contain up to two trigger conditions, and one RS type and up to two different trigger quantities (e.g. RSRP and RSRQ, RSRP and SINR, etc.) may be provided as conditions. The following ASN.1 is the structure of the current RRC signaling for reference.

TABLE 3

| ConditionalReconfiguration-r16 ::= SEQUENCE { | |
|---|---|
| attemptCondReconfig-r16 ENUMERATED {true} OPTIONAL, -- Cond | |
| CHO | |
| condReconfigToRemoveList-r16 | CondReconfigToRemoveList-r16 |
| OPTIONAL, -- Need N | |
| condReconfigToAddModList-r16 | CondReconfigToAddModList-r16 |

```
OPTIONAL, -- Need N
  ...
  CondReconfigToAddModList-r16 ::= SEQUENCE (SIZE (1..
maxNrofCondCells-r16)) OF CondReconfigToAddMod-r16
  CondReconfigToAddMod-r16 ::= SEQUENCE {
  condReconfigId-r16 CondReconfigId-r16,
  condExecutionCond-r16 SEQUENCE (SIZE (1..2)) OF MeasId
OPTIONAL, -- Need M
  condRRCReconfig-r16 OCTET STRING (CONTAINING
RRCReconfiguration ) OPTIONAL, -- Cond condReconfigAdd
  ...,
  [[
  condExecutionCondSCG-r17 OCTET STRING (CONTAINING
CondReconfigExecCondSCG-r17) OPTIONAL -- Need M
  ]]
  }
  CondReconfigExecCondSCG-r17 ::= SEQUENCE (SIZE (1..2)) OF
MeasId
```

A method is described on how to use the CPA and CPC configuration structure described above to support simultaneous configuration of CPA and CPC. 1. How to configure the first CPA/CPC configuration simultaneously: One condReconfig ID 7-10 includes both CPA conditions and CPC conditions.
Option 1-1: different conditions, but applied configuration is equally used as one
1) Type 1 condition: CPA condition (e.g. CondEvent A4)
2) Type 2 condition: CPC Condition (e.g. CondEvent A3)

Here, CondEvent A3 may mean the case where the condition configuration of the candidate cell is better than the PCell/PSCell by an offset, and CondEvent A4 may mean the case where the condition configuration of the candidate cell is greater than the threshold of the absolute value. CondEvent A4 is useful for determining the CPC type because it evaluates the performance of the candidate cell on the basis of the PSCell, and CondEvent A3 is used for determining the CPA type because it evaluates the performance of the candidate cell using the absolute threshold. In addition to the example conditions above, conditions that distinguish between CPC and CPA may be used, or even if the same condition is used, an indicator indicating that the condition is for CPA or CPC may be included.
Option 1-2: There are two configurations for CPA and CPC, one for CPA and one for CPC, which are applied after handover. That is, a new field related to additional SCG configurations for measID2 must be defined.
1) measID1 uses the existing condRRCReconfig 7-30.
2) measID2 uses a new field (e.g. condRRCReconfig2, but the signaling structure is the same or similar to condRRCReconfig 7-30).
2. How to configure the first CPA/CPC configuration simultaneously: Each condReconfig ID 7-10 contains only one type of condition (i.e., condReconfig ID 7-10 contains conditions and configurations for CPA or CPC types, but may not contain both at the same time). The following example explains:
1) When condReconfig ID 7-10 is 1, use CPA type (for the same Measurement object (MO)).
2) When condReconfig ID 7-10 is 2, use CPC type (for the same Measurement object (MO)).

That is, it is possible to use two conditions for one MO, but this is when the condReconfig ID is used separately without structural changes. In this case, the structure and signaling itself may reuse the existing signaling structure, and it is only necessary to allow configuring two conditions for one MO at the same time.

The signaling structure described in FIG. 7 is a feature proposed in the present disclosure and may be applied to the following embodiments. In addition, the CPA and CPC conditions and configuration information proposed in the present disclosure is basically applying delta configuration. Here, the delta configuration may mean a method of providing only the parts where the conditions and configurations for CPAC candidate cells differ on the basis of the reference cell and the configuration of the reference cell as configurations. From the perspective of a receiving terminal, both the reference cell configuration and the delta configuration of the candidate cell may be used to decode and store the actual configuration of the candidate cell and manage it.

In this disclosure, a method for defining and transmitting a reference cell configuration is proposed as follows, and the operation according to each method is dealt with in the following embodiments. Meanwhile, the reference cell configuration may be referred to as a reference cell, a reference configuration, or other terms identical or similar thereto.
1. How to configure the first reference cell: define the current source cell (PCell or SCell) as the reference cell.
   When PCell is a reference cell, the reference cell may be indicated through an explicit cell indicator or implicitly expressed as a reference cell (the standard defines the corresponding rules).
   When SCell is a reference cell, the reference cell may be indicated through an explicit cell indicator (including new indicators).
2. How to configure the second reference cell: define one of the CPA or CPC candidate cells as the reference cell.
   The first candidate cell (condReconfig ID 7-10) is indicated as the reference cell (either explicitly as a designator or implicitly (the standard defines the corresponding rule)).
   A reference cell is indicated through an explicit indicator for one of the CPAC candidate cells.
3. How to configure the third reference cell: define a new additional cell as the reference cell.
   Fields for new cell configurations are defined and configurations for those fields are defined as reference cell configurations.

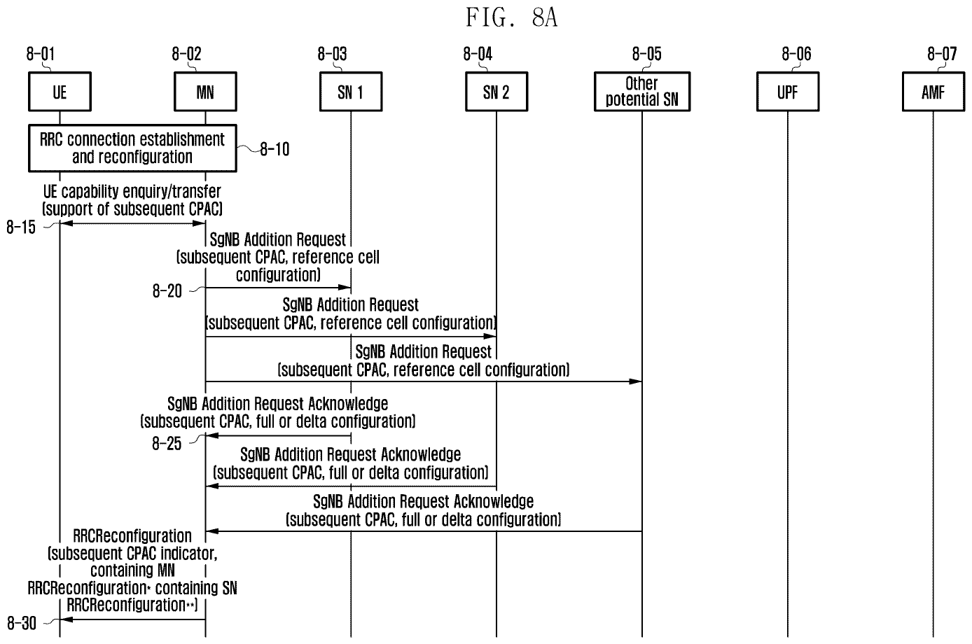

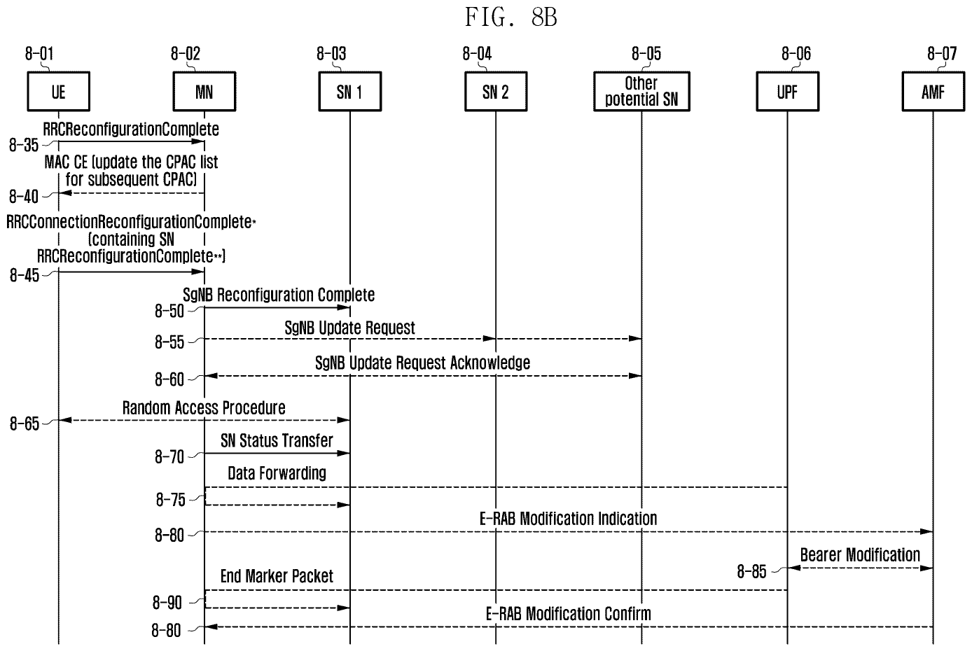

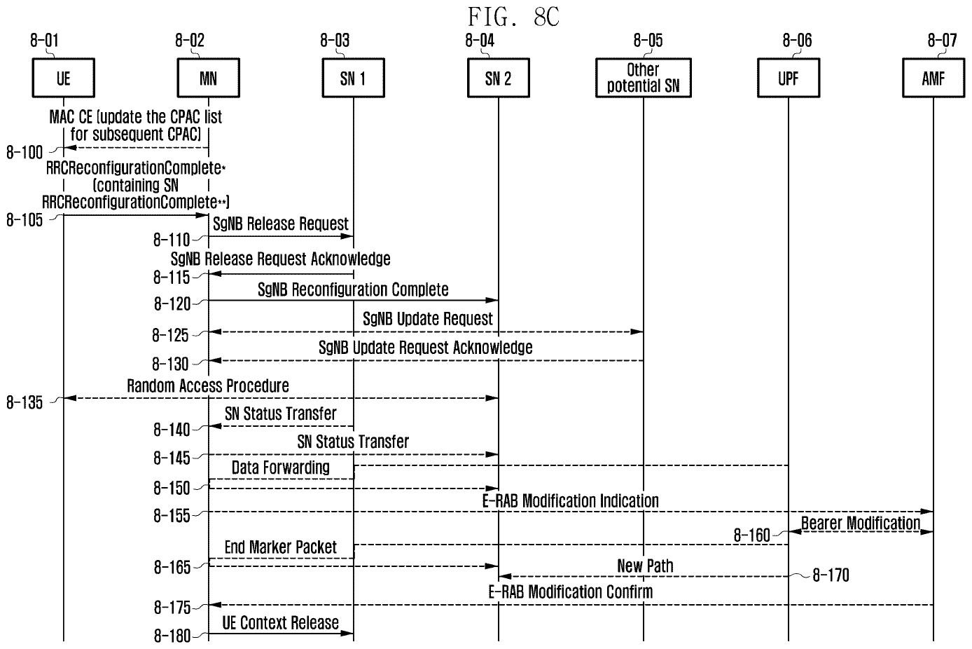

FIGS. 8A, 8B, and 8C are diagrams illustrating the overall operation of performing continuous conditional PSCell addition and change procedures according to one embodiment of the present disclosure.

In this embodiment, in particular, an operation is proposed in which the terminal simultaneously receives configurations for CPA and CPC (e.g., conditions for CPAC and RRC configurations related to SCG) from the base station in a state in which DC is not configured, and stores and manages the corresponding configuration information. That is, even after PSCell addition and change, in the case that the terminal does not additionally receive separate RRC configurations from the base station, the terminal maintains the received configurations and applies them as they are.

With reference to FIGS. 8A, 8B, and 8C, the terminal 8-01 may perform an RRC connection establishment procedure with a master node (MN) 8-02/base station in step 8-10, and perform RRC configurations. In step 8-15, the terminal 8-01 and the MN base station 8-02 may identify the capability of the terminal through a procedure of requesting and transmitting the terminal capability through a terminal capability request (UECapabilityEnquiry) and terminal capability information (UECapabilityInformation) messages. An indicator indicating whether the terminal capability supports continuous CPAC may be included. The terminal capability may be transmitted by one of the feature set methods per terminal, per band, or per band combination, and may be transmitted by distinguishing between CPA and CPC.

In step 8-20, the MN base station 8-02 may identify whether SN addition for the terminal is possible in candidate SN nodes 8-03, 8-04, and 8-05 by identifying the necessity of adding an SN to the terminal. The procedure may be performed through the sgNB Addition Request in step 8-20 and the sgNB Addition Request Acknowledge procedure in step 8-25 with each SN node. An operation for identifying whether continuous CPAC application is possible may be added in the above procedure. For example, the sgNB Addition Request and the sgNB Addition Request Acknowledge may include a continuous CPAC application confirmation indicator and a confirmation indicator. In addition, in step 8-20, at least one of a reference cell and configuration information for the reference cell used for reference when configuring CPAC may be transmitted together. Here, the reference cell may be a cell configured according to any one of the reference cell configuration methods described above. If one of the candidate SNs is used as a reference cell (the second reference cell configuration method), when requesting SN addition through sgNB Addition Request for the corresponding SN 8-03, a full configuration request may be made, and when requesting SN addition through sgNB Addition Request for other SNs 8-04 and 8-05, a delta configuration request may be made. Similarly, in step 8-25, the candidate SN nodes may transmit the configurations for CPAC as full configuration or delta configuration in the response message sgNB Addition Request Acknowledge to the sgNB Addition Request. It is assumed that delta configuration is performed according to the request, but the SN node may reject it and transmit the full configuration. Even in the case of following the remaining reference cell configuration methods, the SN node may transmit an indicator indicating whether the delta configuration is applied by including it in the sgNB Addition Request Acknowledge. Additionally, the Xn message exchange procedure, RRC inter-node message (CG-Config or CG-ConfigInfo) may include a continuous CPAC application confirmation indicator or confirmation indicator.

In step 8-30, the MN base station 8-02 may transmit to the terminal, in the RRC configuration message of the MN, CPAC-related configurations (e.g., conditions for CPAC and RRC configurations related to SCG) received from candidate SNs that allow SN addition, particularly CPAC, in step 8-20 or 8-25. In the EN-DC situation, the CPAC-related configurations for the SN are encapsulated in the RRCConnectionReconfiguration message and transmitted, and, in the NE-DC and NR-DC situations, the CPAC-related configurations for the SN are encapsulated in the RRCReconfiguration message and transmitted. For the convenience of explanation, NR-DC case is assumed in this drawing, but the present disclosure is not limited thereto. The SN CPAC-related configurations included in the RRC configuration may follow the structure and method described in the above-described FIG. 7. That is, in order to support the conditional PSCell addition and change procedures continuously, the CPA and CPC configurations may be configured simultaneously, included in the RRC configurations, and then transmitted to the terminal. When the base station transmits CPAC-related configurations (e.g., conditions for SN CPAC, SCG configurations applied after performing SN CPAC, etc.) to the terminal, the base station may include an indicator (for example, the subsequentCG-Change field below) notifying that the CPAC operation supports the continuous CPAC operation. The terminal that receives the indicator may keep/store the related CPAC configurations even after the SCG change. That is, without releasing the received CPAC configurations, the stored CPAC conditions may be continuously identified even after the SCG change, and if satisfied, the CPC may be triggered and the CPC operation from the existing PSCell to the target PSCell may be performed. The operation continues until a separate release command for the continuous CPAC operation comes from the base station. There may be various ways for the base station to notify that it supports the continuous CPAC operation, and the present disclosure proposes the following methods.
1. Option 1: Notifying and instructing the terminal to support continuous CPAC in RRC message
1) Option 1-1: A method to inform that continuous CPAC is supported commonly for all SNs provided by the base station.
   See Option 1-1 signaling method below (subsequentCG-Change-r18; ENUMERATE {enable}).
   Indicating whether to enable the operation by extending ConditionalReconfiguration-r16 IE to signal or introducing a new field in another IE within MN RRCReconfiguration.
   This field may also be used to enable/disable continuous CPAC operation, and in the case that this field signaling is absent, it may indicate that CPAC operation is disabled.
   Signaling is also possible in the form of ENUMERATE {activate, deactivate}.
2) Option 1-2: A method of individually notifying each SN that continuous CPAC is supported by the CPAC configurations provided by the base station.
   See Option 1-2 signaling method below (subsequentCG-Change-r18; ENUMERATED {reserved, unreserved}).
   Indicating whether to enable the corresponding operation by extending CondReconfigToAddMod-r16 IE. That is, the terminal identifies whether continuous CPAC is applied for each CPAC configuration, and stores/maintains the relevant configuration (the configuration is not released even after SCG change).
   A separate signaling may be used to indicate whether continuous CPAC operation is enabled/disabled for all CPAC configurations other than the corresponding field, and the signaling introduced in option 1-1 may be applied.

```
TABLE 4
  ConditionalReconfiguration-r16 ::= SEQUENCE
  attemptCondReconfig-r16 ENUMERATED {true} OPTIONAL, -- Cond
CHO
```

| | |
|---|---|
| condReconfigToRemoveList-r16 | CondReconfigToRemoveList-r16 |

OPTIONAL, -- Need N

| | |
|---|---|
| condReconfigToAddModList-r16 | CondReconfigToAddModList-r16 |

```
OPTIONAL, -- Need N
  ... ,
  // Option 1-1
  [[ subsequentCG-Change-r18 ENUMERATED
{enabled} OPTIONAL -- Need R
  ]]
  CondReconfigToAddModList-r16 ::= SEQUENCE (SIZE (1..
maxNrofCondCells-r16)) OF CondReconfigToAddMod-r16
  CondReconfigToAddMod-r16 ::= SEQUENCE {
  condReconfigId-r16 CondReconfigId-r16,
  condExecutionCond-r16 SEQUENCE (SIZE (1..2)) OF MeasId
OPTIONAL, -- Need M
  condRRCReconfig-r16 OCTET STRING (CONTAINING
RRCReconfiguration ) OPTIONAL, -- Cond condReconfigAdd
  ...,
  [[
  condExecutionCondSCG-r17 OCTET STRING (CONTAINING
CondReconfigExecCondSCG-r17) OPTIONAL -- Need M
  ]] ,
  // Option 1-2
  [[ subsequentCG-Change-r18 ENUMERATED
{reserved, unreserved} OPTIONAL, -- Need R
  ]]
  }
  CondReconfigExecCondSCG-r17 ::= SEQUENCE (SIZE (1..2)) OF
MeasId
```

2. Option 2: Instructing continuous CPAC operation and updating applicable configurations through MAC CE signaling—introduction of MAC CE with new LCID or eLCTD
   Including a field to indicate enable/disable of continuous CPAC operation (this field may be applied to the entire CPAC configuration or to individual CPAC configurations).
   Additional application is possible to the RRC signaling method of Option 1 above.
   Using for the purpose of signaling updates for continuous CPAC operation with reduced latency and less signaling when support for SN CPAC operation needs to be changed on the basis of inter-node RRC messages with SN and negotiation through Xn interface.

As explained above, the option 2 may be used in step 8-40 and may be omitted in the case that the RRC configurations are replaced and used (repeating steps 8-30/8-35).

In step 8-35, the terminal may transmit an RRCReconfigurationComplete message to the MN base station 8-02 in response to the received RRC configuration (including configurations for MN and SN, particularly including CPAC related configurations), and thereafter, in the case that a CPAC related condition received from a specific SN (SN 1) 8-02 is satisfied, the terminal may trigger an SN addition procedure for the corresponding SN (SN 1) 8-02. That is, in step 8-40, the terminal may generate an MN RRCReconfigurationComplete message including an SN RRCReconfigurationComplete message for the SN for which the SN addition procedure is triggered (the SN for which the CPA condition is satisfied) and transmit it to the MN base station 8-02. In step 8-50, the MN base station 8-02 transmits an sgNB Reconfiguration Complete message to the SN base station 8-03 where the CPA condition is satisfied, i.e., the terminal performs SN addition, to notify the SN addition operation of the terminal. In addition, in step 8-55, a procedure for identifying the validity of the CPAC configurations transmitted to the terminal may be performed for candidate SN base stations to which SN addition has not been performed. That is, in the step, it may be requested whether the previously provided (continuous) CPAC configurations are valid even after the SCG change or whether they need to be updated. The message may be a sgNB Update Request message or another Xn message, or may be an RRC inter-node message. In step 8-60, each candidate SN may transmit an SgNB Release Request Acknowledge or RRC inter-node message including update information of the (continuous) CPAC configurations in response to the above message. Meanwhile, the procedures 8-55 and 8-60 may be omitted depending on the implementation. Additionally, at that stage, delta configuration and full configuration requests for CPAC configurations and CPAC configurations accordingly may be performed.

In step 8-65, the terminal may perform a procedure for random access for SN addition for the SN for which CPA is triggered. This operation is performed only when a security key update is required, and may be omitted in other cases. In step 8-70, the MN base station 8-02 may transmit SN (sequence number) Status to the SN base station 8-03, and in step 8-75, perform a procedure for transmitting data from the UPF 8-06 to the SN base station 8-03. In addition, as an action for path update in step 8-80, the MN base station 8-02 may transmit a PDU session resource change indicator to the AMF 8-07, in step 8-85, the AMF 8-07 and the UPF 8-06 may perform a bearer modification procedure, and in step 8-90, the UPF 8-06 may transmit a PDU packet including an End marker to the MN base station 8-02 to indicate a change of the previous bearer. In step 8-95, the AMF 8-07 may transmit a PDU session resource change acknowledge message to the MN base station 8-02 to indicate that the PDU session resource change is completed.

As described above, the procedure for indicating an update for continuous CPAC operation may be triggered at any time by confirmation between base stations. For example, information about an SN to which continuous CPAC operation is applied may be updated through a new MAC (medium access control) CE (control element), such as step 8-100. Or, CPAC configurations may be explicitly modified and released through an RRC message. In this step, the CPA and CPC configurations, which are the focus of the embodiment of the present disclosure, may be transmitted simultaneously, and the validity of the continuous CPA and CPC configurations may also be indicated by an update through the MAC CE.

Thereafter, in the case that the CPAC related conditions received from a specific SN are satisfied, the terminal may trigger an SN change procedure for the corresponding SN. That is, in step 8-105, the terminal may generate an MN RRCReconfigurationComplete message including an SN RRCReconfigurationComplete message for the SN (SN 2) 8-04 for which the SN change procedure is triggered (the SN for which the CPAC condition is satisfied) and transmit it to the MN base station 8-02. In step 8-110, the MN base station 8-02 transmits an SgNB Release Request message requesting SCG configuration release to the source SN base station 8-03, and in step 8-15, the source SN base station 8-03 responds by transmitting an SgNB Release Request Acknowledge message. In step 8-120, the MN base station 8-02 transmits an sgNB Reconfiguration Complete message to the target SN base station (SN 2) 8-04 where the CPAC condition is satisfied, i.e., the terminal performs SN change, to notify the SN change operation of the terminal. In addition, in step 8-125, a procedure for identifying the validity of the CPAC configurations transmitted to the terminal may be performed on the candidate SN base stations 8-05 where the SN has not been changed. That is, in the step, it may be requested whether the previously provided (continuous) CPAC configurations are still valid after the SCG change or whether an update is required. The message may be a SgNB Update Request message or another Xn message, or may be an RRC inter-node message. In step 8-130, each candidate SN may transmit an SgNB Release Request Acknowledge or RRC inter-node message including update information of the (continuous) CPAC configurations in response to the message. Meanwhile, the 8-125 and 8-130 procedures may be omitted depending on the implementation. At this stage, delta configuration and full configuration requests for CPAC configurations and CPAC configurations according to them may be performed. In addition, although the continuous CPAC operations that may be repeatedly performed thereafter are omitted in this drawing, the terminal may continue to apply the received CPAC configurations and perform related operations (CPC trigger and CPC execution).

In step 8-135, the terminal may perform a random access procedure for SN change for the target SN (SN2) 8-04 where the CPC is triggered. This operation is performed only when a security key update is required, and may be omitted in other cases. In step 8-140, the MN base station 8-02 may receive SN (sequence number) Status from the source SN base station 8-03, and transfer the SN (sequence number) Status received in step 8-145 to the target SN base station 8-04. In step 8-150, a procedure for transferring data from the UPF 8-06 to the target SN base station 8-04 may be performed. In addition, as an action for path update in step 8-155, the MN base station 8-02 may transmit a PDU session resource change indicator to the AMF 8-07, in step 8-160, the AMF 8-07 and the UPF 8-06 may perform a bearer modification procedure, and in step 8-165, the UPF 8-06 may transmit a PDU packet including an End marker to the MN base station 8-02 to instruct a change of the previous bearer. In step 8-170, the UPF 8-06 may instruct a new path to the target SN base station 8-04. In step 8-175, the AMF 8-07 transmits a PDU session resource change confirmation message to the MN base station 8-02 indicating that the PDU session resource change has been completed, and in step 8-180, the MN base station 8-02 may instruct the source SN base station 8-03 to release the terminal context.

Meanwhile, although steps 8-10 to 8-180 are illustrated as being performed sequentially in FIGS. 8A, 8B, and 8C, the present disclosure is not limited thereto. For example, some of steps 8-10 to 8-180 may be performed in different orders or simultaneously. In addition, some of steps 8-10 to 8-180 may be omitted.

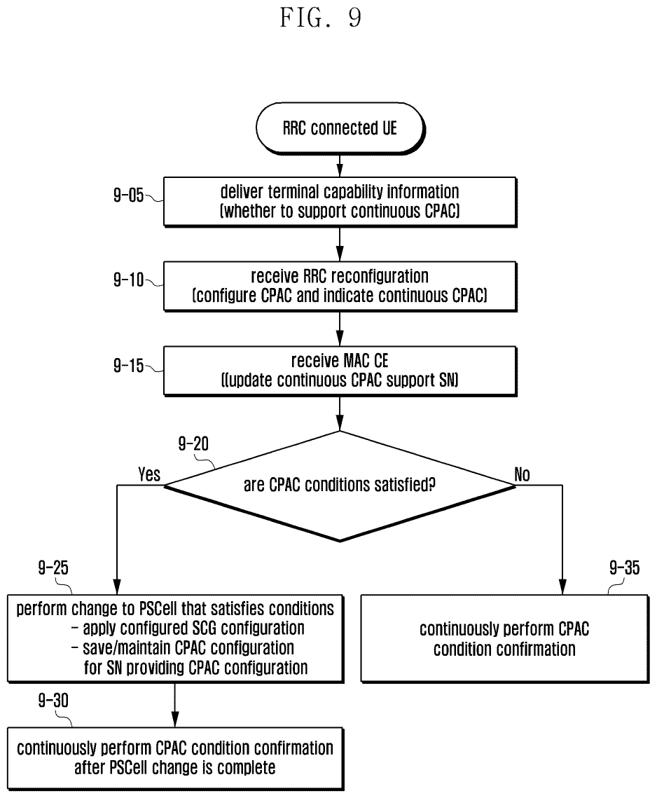

FIG. 9 is a diagram illustrating a terminal operation according to one embodiment of the present disclosure, specifically the terminal operation when conditional PSCell addition and change are applied continuously.

With reference to FIG. 9, in step 9-05, a terminal may transmit a terminal capability through a terminal capability information (UECapabilityInformation) message according to a request (UECapabilityEnquiry) of a base station. The terminal capability may include an indicator indicating whether continuous CPAC is supported. The terminal capability may be transmitted by one of the feature set methods per terminal, per band, or per band combination, and may be transmitted by distinguishing between CPA and CPC. In step 9-10, the terminal may receive an RRC configuration from the base station, and the configuration may include a basic configuration for data transmission and reception. In addition, the RRC configuration may include a CPAC configuration for a plurality of SNs and an indicator indicating that continuous CPAC is applied. The received CPAC configuration may be transmitted with a delta configuration applied to a reference cell and a reference cell configuration, in which case the terminal may decode the configuration on the basis of the reference cell configuration to generate, store, and manage the entire cell configuration. Or, at that stage, the terminal stores and manages the received configurations as they are, and CPAC is actually triggered. When possible, the configurations for the target cell may be applied by decoding on the basis of the reference cell configurations. In addition, in the step, the continuous CPA and CPC configurations that are focused on in the present disclosure may be received by the terminal at the same time, and the terminal can apply or store the configurations as they are, and perform the CPAC operation according to the conditions thereafter. In the step 9-15, the terminal may additionally receive a MAC CE for updating activation/deactivation information for an SN that supports continuous CPAC from the base station. The MAC CE operation may be omitted, and when the information is not present, the CPAC related configurations configured by RRC may be applied and operated.

In step 9-20, when the terminal receives the RRC configuration and MAC CE signaling, the terminal continuously identifies the CPAC triggering conditions included in the CPAC configuration, and in the case that the conditions are satisfied, the terminal may add a PSCell satisfying the conditions or perform a change to the corresponding PSCell in step 9-25. That is, the SCG configuration information provided in the CPAC configuration may be applied, and in the case that random access is required for the corresponding PSCell, random access may be performed, and uplink synchronization may be achieved. That is, the terminal may perform an operation for changing the PSCell, and additionally store/maintain the CPAC configuration for the SN providing the CPAC configuration. The storing/maintaining of the CPAC related configuration for the SN providing the CPAC configuration may be updated according to the RRC configuration provided in step 9-10 and the MAC CE signaling in step 9-15. That is, it may be updated according to the most recently provided information. After completing the change to the target PSCell in step 9-30, the terminal may continue to identify the channel measurement values and CPAC conditions and perform CPAC operation on the basis of the CPAC configuration for the SN that supports continuous CPAC operation stored. After that, the terminal may perform the operation after step 9-10 or step 9-15 according to the base station signaling.

In step 9-20, when the terminal receives the RRC configuration and MAC CE signaling, the terminal may continue to identify the CPAC triggering conditions included in the CPAC configuration in step 9-35. The terminal may perform operations after step 9-10 or step 9-15 according to base station signaling.

Meanwhile, although steps 9-05 to 9-35 are illustrated as being performed sequentially in FIG. 9, the present disclosure is not limited thereto. For example, some of steps 9-05 to 9-35 may be performed in different orders or may be performed simultaneously. In addition, some of steps 9-05 to 9-35 may be omitted.

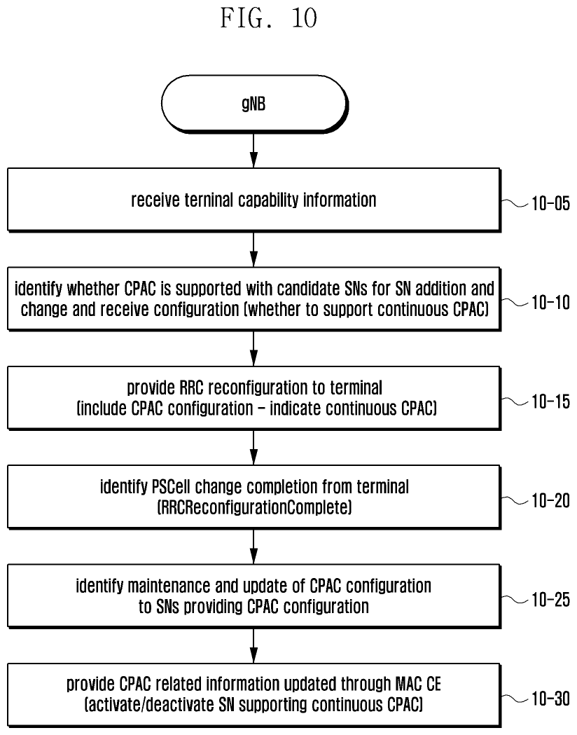

FIG. 10 is a diagram illustrating a base station operation according to one embodiment of the present disclosure, specifically the base station operation when conditional PSCell addition and change are applied continuously.

With reference to FIG. 10, in step 10-05, the base station may transmit a UECapabilityEnquiry message to acquire a terminal capability, and accordingly, may receive the terminal capability through a UECapabilityInformation message. The terminal capability may include an indicator indicating whether continuous CPAC is supported. The terminal capability may be transmitted by one of the featureset methods per terminal, per band, or per band combination, and may be transmitted by distinguishing between CPA and CPC. The base station may identify the terminal capability and then identify whether to instruct continuous CPAC operation through RRC configuration. In step 10-10, the base station may perform negotiation for CPAC support confirmation and related configurations with SNs that are candidates for SN addition and change. In this step, whether continuous CPAC is supported for each SN may be identified, and CPAC configuration for CPAC candidate SNs may be received on the basis of delta configuration on the basis of reference cell configuration information. Or, it can be received as full configuration. In addition, an indicator indicating this may be added. On the basis of this, CPAC related configurations may be delivered to the terminal through RRC re-establishment in step 10-15. That is, an indicator that instructs continuous CPAC operation according to the configurations provided by each SN may be provided to the terminal together with the CPAC configurations.

In step 10-20, the base station may receive (reception of SN RRC completion message included in MN RRC message) from the terminal an RRCReconfigurationComplete message in response to the RRC reconfiguration that provided the SN configuration (CPAC configuration), and may identify that the PSCell change is completed. In step 10-25, the MN base station may identify whether there is (continuous) CPAC configuration maintenance and update from the SNs that provided the CPAC configuration. After the consultation with the SN nodes in the step, in the case that the (continuous) CPAC configuration is updated, the base station may indicate it through MAC CE. Also, the RRC reconfiguration in step 10-15 may be performed instead of the MAC CE signaling in step 10-30. Also, since there may be an update to the continuous CPAC procedure at any time, the procedures 10-10 to 10-30 may be re-performed through a confirmation procedure between base stations.

Meanwhile, although steps 10-05 to 10-30 are illustrated as being performed sequentially in FIG. 10, the present disclosure is not limited thereto. For example, some of steps 10-05 to 10-30 may be performed in different orders or simultaneously. In addition, some of steps 10-05 to 10-30 may be omitted.

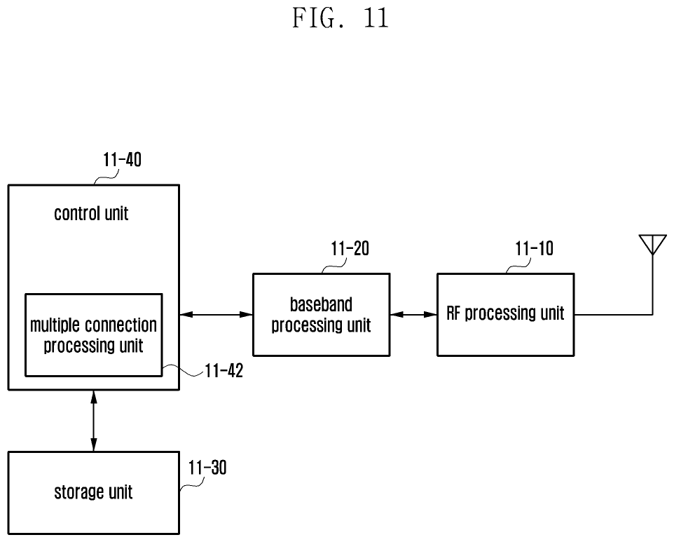

FIG. 11 is a block diagram illustrating a configuration of a terminal according to one embodiment of the present disclosure.

With reference to FIG. 11, the terminal may include a radio frequency (RF) processing unit 11-10, a baseband processing unit 11-20, a storage unit 11-30, and a control unit 11-40.

The RF processing unit 11-10 performs functions for transmitting and receiving signals through a wireless channel, such as signal band conversion and amplification. That is, the RF processing unit 11-10 up-converts a baseband signal provided from the baseband processing unit 11-20 into an RF band signal and transmits it through an antenna, and down-converts an RF band signal received through the antenna into a baseband signal. For example, the RF processing unit 11-10 may include a transmission filter, a reception filter, an amplifier, a mixer, an oscillator, a digital to analog convertor (DAC), an analog to digital convertor (ADC), etc. In the drawing, only one antenna is illustrated, but the terminal may be equipped with multiple antennas. In addition, the RF processing unit 11-10 may include multiple RF chains. Furthermore, the RF processing unit 11-10 may perform beamforming. For the beamforming, the RF processing unit 11-10 may adjust the phase and size of each signal transmitted and received through multiple antennas or antenna elements. In addition, the RF processing unit may perform MIMO and receive multiple layers when performing a MIMO operation.

The baseband processing unit 11-20 performs a conversion function between a baseband signal and a bit stream according to the physical layer specifications of the system. For example, when transmitting data, the baseband processing unit 11-20 generates complex symbols by encoding and modulating a transmission bit stream. In addition, when receiving data, the baseband processing unit 11-20 restores a reception bit stream by demodulating and decoding a baseband signal provided from the RF processing unit 11-10. For example, in the case of following the OFDM (orthogonal frequency division multiplexing) method, when transmitting data, the baseband processing unit 11-20 generates complex symbols by encoding and modulating a transmission bit stream, maps the complex symbols to subcarriers, and then configures OFDM symbols by performing an IFFT (inverse fast Fourier transform) operation and CP (cyclic prefix) insertion. In addition, when receiving data, the baseband processing unit 11-20 divides the baseband signal provided from the RF processing unit 11-10 into OFDM symbol units and divides it into subcarriers through FFT (fast Fourier transform) operation. After restoring the mapped signals, the received bit string is restored through demodulation and decoding.

The baseband processing unit 11-20 and the RF processing unit 11-10 transmit and receive signals as described above. Accordingly, the baseband processing unit 11-20 and the RF processing unit 11-10 may be referred to as a transmitter, a receiver, a transceiver, or a communication unit. Furthermore, at least one of the baseband processing unit 11-20 and the RF processing unit 11-10 may include a plurality of communication modules to support a plurality of different wireless access technologies. In addition, at least one of the baseband processing unit 11-20 and the RF processing unit 11-10 may include different communication modules to process signals of different frequency bands. For example, the different wireless access technologies may include a wireless LAN (e.g., IEEE 802.11), a cellular network (e.g., LTE), etc. Additionally, the different frequency bands may include super high frequency (SHF) (e.g., 2.NRHz, NRhz) bands, millimeter wave (mm wave) (e.g., 60 GHz) bands.

The storage unit 11-30 stores data such as basic programs, application programs, and configuration information for the operation of the terminal. In particular, the storage unit 11-30 may store information related to a second access node that performs wireless communication using a second wireless access technology. In addition, the storage unit 11-30 provides stored data according to a request from the control unit 11-40.

The control unit 11-40 controls the overall operations of the terminal. For example, the control unit 11-40 transmits and receives signals through the baseband processing unit 11-20 and the RF processing unit 11-10. In addition, the control unit 11-40 records and reads data in the storage unit 11-30. For this purpose, the control unit 11-40 may include at least one processor. For example, the control unit 11-40 may include a CP (communication processor) that performs control for communication and an AP (application processor) that controls upper layers such as application programs.

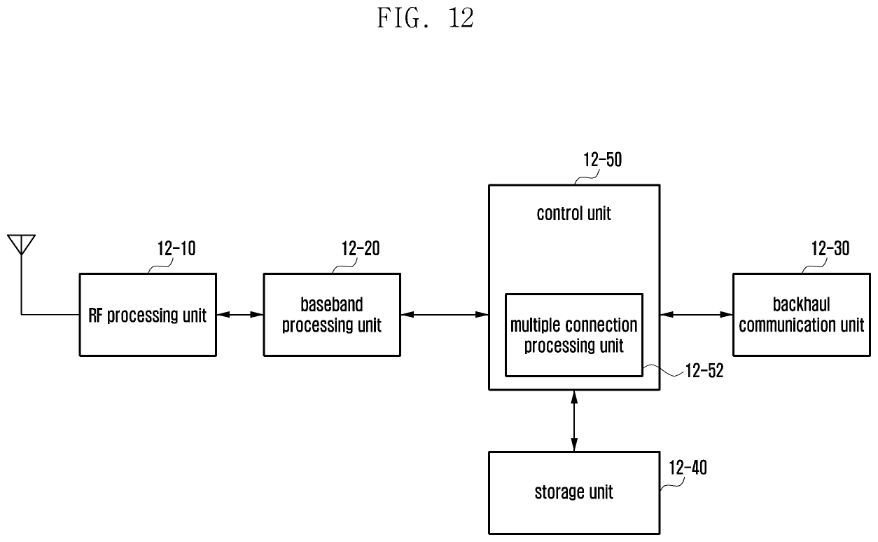

FIG. 12 is a block diagram illustrating a configuration of a base station according to one embodiment of the present disclosure.

With reference to FIG. 12, the base station is configured to include an RF processing unit 12-10, a baseband processing unit 12-20, a backhaul communication unit 12-30, a storage unit 12-40, and a control unit 12-50.

The RF processing unit 12-10 performs functions for transmitting and receiving signals through a wireless channel, such as signal band conversion and amplification. That is, the RF processing unit 12-10 up-converts a baseband signal provided from the baseband processing unit 12-20 into an RF band signal and transmits it through an antenna, and down-converts an RF band signal received through the antenna into a baseband signal. For example, the RF processing unit 12-10 may include a transmission filter, a reception filter, an amplifier, a mixer, an oscillator, a DAC, an ADC, etc. In the drawing, only one antenna is shown, but the first access node may have multiple antennas. In addition, the RF processing unit 12-10 may include multiple RF chains. Furthermore, the RF processing unit 12-10 may perform beamforming. For the beamforming, the RF processing unit 12-10 may adjust the phase and size of each signal transmitted and received through multiple antennas or antenna elements. The RF processing unit may perform a downward MIMO operation by transmitting one or more layers.

The baseband processing unit 12-20 performs a conversion function between a baseband signal and a bit stream according to the physical layer specifications of the first wireless access technology. For example, when transmitting data, the baseband processing unit 12-20 encodes and modulates a transmission bit stream to generate complex symbols. In addition, when receiving data, the baseband processing unit 12-20 restores a reception bit stream by demodulating and decoding a baseband signal provided from the RF processing unit 12-10. For example, in the case of following the OFDM method, when transmitting data, the baseband processing unit 12-20 encodes and modulates a transmission bit stream to generate complex symbols, maps the complex symbols to subcarriers, and then configures OFDM symbols through an IFFT operation and CP insertion. In addition, when receiving data, the baseband processing unit 12-20 divides the baseband signal provided from the RF processing unit 12-10 into OFDM symbol units and divides it into subcarriers through FFT operation. After restoring the mapped signals, the received bit stream is restored through demodulation and decoding. The baseband processing unit 12-20 and the RF processing unit 12-10 transmit and receive signals as described above. Accordingly, the baseband processing unit 12-20 and the RF processing unit 12-10 may be referred to as a transmitter, a receiver, a transceiver, a communication unit, or a wireless communication unit.

The backhaul communication unit 12-30 provides an interface for performing communication with other nodes within the network. That is, the backhaul communication unit 12-30 converts a bit string transmitted from the main base station to another node, such as an auxiliary base station, a core network, etc., into a physical signal, and converts a physical signal received from the other node into a bit string.

The storage unit 12-40 stores data such as basic programs, application programs, and configuration information for the operation of the base station. In particular, the storage unit 12-40 may store information on bearers allocated to connected terminals, measurement results reported from connected terminals, etc. In addition, the storage unit 12-40 may store information that serves as a judgment criterion for whether to provide multiple connections to a terminal or to terminate them. In addition, the storage unit 12-40 provides stored data according to a request from the control unit 12-50.

The control unit 12-50 controls the overall operations of the base station. For example, the control unit 12-50 transmits and receives signals through the baseband processing unit 12-20 and the RF processing unit 12-10 or through the backhaul communication unit 12-30. In addition, the control unit 12-50 records and reads data in the storage unit 12-40. For this purpose, the control unit 12-50 may include at least one processor.

The methods according to the embodiments described in the claims or specification of the present disclosure may be implemented in the form of hardware, software, or a combination of hardware and software.

In the case of software implementation, a computer-readable storage medium storing one or more programs (software modules) may be provided. The one or more programs stored in the computer-readable storage medium are configured for execution by one or more processors in an electronic device. The one or more programs include instructions that enable the electronic device to execute methods according to embodiments described in the claims or specification of the present disclosure.

These programs (software modules, software) may be stored in a random access memory, a non-volatile memory including a flash memory, a ROM (Read Only Memory), an Electrically Erasable Programmable Read Only Memory (EEPROM), a magnetic disc storage device, a Compact Disc-ROM (CD-ROM), a Digital Versatile Discs (DVDs) or other forms of optical storage devices, a magnetic cassette. Or, they may be stored in a memory composed of a combination of some or all of these. In addition, each configuration memory may be included in multiple numbers.

Additionally, the program may be stored in an attachable storage device that is accessible through a communications network, such as the Internet, an Intranet, a Local Area Network (LAN), a Wide LAN (WLAN), or a Storage Area Network (SAN), or a combination thereof. The storage device may be connected to the device performing the embodiments of the present disclosure through an external port. Additionally, a separate storage device on the communications network may be connected to the device performing the embodiments of the present disclosure.

In the specific embodiments of the present disclosure described above, the components included in the invention are expressed in the singular or plural form according to the specific embodiments presented. However, the singular or plural expressions are selected appropriately for the presented situation for the convenience of explanation, and the present disclosure is not limited to the singular or plural components, and even if a component is expressed in the plural form, it may be composed of the singular form, or even if a component is expressed in the singular form, it may be composed of the plural form.

Meanwhile, the embodiments of the present disclosure disclosed in this specification and drawings are only specific examples to easily explain the technical content of the present disclosure and help understand the present disclosure, and are not intended to limit the scope of the present disclosure. That is, it is obvious to a person having ordinary knowledge in the technical field to which the present disclosure belongs that other modified examples on the basis of the technical idea of the present disclosure are possible. In addition, each of the above embodiments can be combined and operated with each other as needed. For example, parts of one embodiment of the present disclosure and another embodiment may be combined with each other to operate a base station and a terminal.

Meanwhile, the order of description in the drawings explaining the method of the present disclosure does not necessarily correspond to the order of execution, and the order of precedence may be changed or executed in parallel.

Alternatively, the drawings illustrating the method of the present disclosure may omit some components and include only some components without damaging the essence of the invention.

In addition, the method of the present disclosure may be implemented by combining part or all of the contents included in each embodiment within a scope that does not harm the essence of the invention.

Various embodiments of the present disclosure have been described above. The description of the present disclosure as described above is for illustrative purposes, and the embodiments of the present disclosure are not limited to the disclosed embodiments. Those skilled in the art to which the present disclosure pertains will understand that the present disclosure can be easily modified into other specific forms without changing the technical idea or essential features of the present disclosure. The scope of the present disclosure is indicated by the claims described below rather than the detailed description above, and all changes or modifications derived from the meaning and scope of the claims and their equivalent concepts should be interpreted as being included in the scope of the present disclosure.

1. A method performed by a terminal in a wireless communication system, the method comprising:
receiving, from a base station, a radio resource control (RRC) reconfiguration message comprising at least one of configuration information for a conditional primary secondary cell group (SCG) cell (PSCell) addition and or configuration information for a conditional PSCell change;
as a response to the RRC reconfiguration message, transmitting, to the base station, an RRC reconfiguration complete message;
identifying whether a condition for the conditional PSCell addition or the conditional PSCell change is satisfied; and
in case that the condition is satisfied, performing the conditional PSCell addition or the conditional PSCell change,
wherein the at least one of the configuration information for the conditional PSCell addition or the configuration information for the conditional PSCell change is maintained for a subsequent addition or change of a PSCell.

2. The method of claim 1,
wherein the at least one of the configuration information for the conditional PSCell addition or the configuration information for the conditional PSCell change is maintained until information for new conditional PSCell addition or conditional PSCell change, or a message associated with a release of configuration information is received from the base station after the conditional PSCell addition or the conditional PSCell change.

3. The method of claim 1,
wherein the RRC reconfiguration message further comprises at least one of condition information for the conditional PSCell addition or condition information for the conditional PSCell change, and
wherein a subsequent conditional PSCell addition or a subsequent conditional PSCell change is performed based on at least one of the condition information for the conditional PSCell addition, the configuration information for the conditional PSCell addition, the condition information for the conditional PSCell change, or the configuration information for the conditional PSCell change.

4. The method of claim 3,
wherein the RRC reconfiguration message further comprises information on a cell that serves as a reference, and
wherein condition or configuration information differing from the information on the cell is configured based on the information on the cell.

5. A method performed by a base station in a wireless communication system, the method comprising:
transmitting, to a terminal, a radio resource control (RRC) reconfiguration message comprising at least one of configuration information for a conditional primary secondary cell group (SCG) cell (PSCell) addition or configuration information for a conditional PSCell change; and
as a response to the RRC reconfiguration message, receiving, from the terminal, an RRC reconfiguration complete message,
wherein, in case that a condition is satisfied, the conditional PSCell addition or the conditional PSCell change is performed, and
wherein the at least one of the configuration information for the conditional PSCell addition or the configuration information for the conditional PSCell change is maintained for a subsequent addition or change of a PSCell.

6. The method of claim 5, further comprising:
transmitting, to the terminal, information for new conditional PSCell addition or conditional PSCell change, or a message associated with a release of configuration information after the conditional PSCell addition or the conditional PSCell change.

7. The method of claim 5,
wherein the RRC reconfiguration message further comprises at least one of condition information for the conditional PSCell addition or condition information for the conditional PSCell change, and
wherein a subsequent conditional PSCell addition or a subsequent conditional PSCell change is performed based on at least one of the condition information for the conditional PSCell addition, the configuration information for the conditional PSCell addition, the condition information for the conditional PSCell change, or the configuration information for the conditional PSCell change.

8. The method of claim 7,
wherein the RRC reconfiguration message further comprises information on a cell that serves as a reference, and
wherein condition or configuration information differing from the information on the cell is configured to the terminal based on the information on the cell.

9. A terminal in a wireless communication system, the terminal comprising:
a transceiver; and
at least one processor coupled with the transceiver and configured to:
receive, from a base station, a radio resource control (RRC) reconfiguration message comprising at least one of configuration information for a conditional primary secondary cell group (SCG) cell (PSCell) addition or configuration information for a conditional PSCell change,
as a response to the RRC reconfiguration message, transmit, to the base station, an RRC reconfiguration complete message,
identify whether a condition for the conditional PSCell addition or the conditional PSCell change is satisfied, and
in case that the condition is satisfied, perform the conditional PSCell addition or the conditional PSCell change,
wherein the at least one of the configuration information for the conditional PSCell addition or the configuration information for the conditional PSCell change is maintained for a subsequent addition or change of a PSCell.

10. The terminal of claim 9,
wherein the at least one of the configuration information for the conditional PSCell addition or the configuration information for the conditional PSCell change is maintained until information for new conditional PSCell addition or conditional PSCell change, or a message associated with a release of configuration information is received from the base station after the conditional PSCell addition or the conditional PSCell change.

11. The terminal of claim 9,
wherein the RRC reconfiguration message further comprises at least one of condition information for the conditional PSCell addition or condition information for the conditional PSCell change, and
wherein a subsequent conditional PSCell addition or a subsequent conditional PSCell change is performed based on at least one of the condition information for the conditional PSCell addition, the configuration information for the conditional PSCell addition, the condition information for the conditional PSCell change, or the configuration information for the conditional PSCell change.

12. The terminal of claim 11,
wherein the RRC reconfiguration message further comprises information on a cell that serves as a reference, and
wherein condition or configuration information differing from the information on the cell is configured based on the information on the cell.

13. A base station in a wireless communication system, the base station comprising:
a transceiver; and
at least one processor coupled with the transceiver and configured to:
transmit, to a terminal, a radio resource control (RRC) reconfiguration message comprising at least one of configuration information for a conditional primary secondary cell group (SCG) cell (PSCell) addition or configuration information for a conditional PSCell change, and
as a response to the RRC reconfiguration message, receive, from the terminal, an RRC reconfiguration complete message,
wherein, in case that a condition is satisfied, the conditional PSCell addition or the conditional PSCell change is performed, and
wherein the at least one of the configuration information for the conditional PSCell addition or the configuration information for the conditional PSCell change is maintained for a subsequent addition or change of a PSCell.

14. The base station of claim 13, wherein the at least one processor is further configured to:
transmit, to the terminal, information for new conditional PSCell addition or conditional PSCell change, or a message associated with a release of configuration information after the conditional PSCell addition or the conditional PSCell change.

15. The base station of claim 13,
wherein the RRC reconfiguration message further comprises at least one of information on a cell that serves as a reference, condition information for the conditional PSCell addition, or condition information for the conditional PSCell change,
wherein a subsequent conditional PSCell addition or a subsequent conditional PSCell change is performed based on at least one of the condition information for the conditional PSCell addition, the configuration information for the conditional PSCell addition, the condition information for the conditional PSCell change, or the configuration information for the conditional PSCell change, and
wherein condition or configuration information differing from the information on the cell is configured to the terminal based on the information on the cell.
